(19) United States
(12) Patent Application Publication
(10) Pub. No.: US 2017/0314140 A1
(43) Pub. Date: Nov. 2, 2017

(54) Method for the Wet Chemical Polishing of Molded Zinc Parts

(71) Applicant: POLIGRAT GmbH, Munchen (DE)

(72) Inventors: Siegfried Piesslinger-Schweiger, Vaterstetten (DE); Olaf Boehme, Erding (DE); Bastian Reising, Alzenau-Wasserlos (DE)

(21) Appl. No.: 15/516,134

(22) PCT Filed: Aug. 27, 2015
(86) PCT No.: PCT/EP2015/069595

§ 371 Date: Mar. 31, 2017

(30) Foreign Application Priority Data
Oct. 2, 2014 (EP) 14003409.1

(51) Int. Cl. C23F 1/30; C01B 17/69; C01B 25/18; C22B 19/00

(52) U.S. Cl. CPC C23F 1/30; C22B 19/00; C01B 17/69; C01B 25/18

(57) ABSTRACT

A method for the wet-chemical polishing of molded zinc parts, the molded parts being brought in contact with an acid solution and said acid solution containing only sulfuric acid and phosphoric acid as the strong acids.

The present invention relates to a method for the wet chemical polishing of molded parts made of zinc. In the method according to the invention, it is of particular importance to work without chromic acid or chromates, without nitric acid or nitrates, without hydrofluoric acid or fluorides, and without hydrochloric acid or chlorides.

Zinc, in particular in the form of diecast zinc, is widely used for manufacturing a large variety of parts which often have complex shapes. After casting, the parts must undergo multiple mechanical machining operations by drilling, thread cutting, grinding, turning, and milling. In the process, the surface is roughened, resulting in undesirable burrs. Smoothing of the surface and removal of burrs is generally carried out by grinding, vibratory grinding, and polishing. Often, this represents a high level of effort and does not yield the desired result, in particular when the surfaces to be machined are not amenable to, or are poorly suited for, mechanical methods.

Parts made of diecast zinc are often surface-coated for decorative reasons and for corrosion protection. This usually takes place by electroplating or painting. For both methods, the surfaces in the initial state must be clean, free of burrs and scale, and as smooth as possible.

For other metals and alloys, similar problems are often solved by chemical or electrochemical polishing and deburring. These wet chemical methods reach the entire surface of the parts, and result in smooth, clean metallic surfaces. In contrast to mechanical methods, the wet chemical methods are easily and cost-effectively integrated into electroplating facilities or painting facilities.

For diecast zinc, neither chemical nor electrochemical methods are available that are suitable for industrial use. In the past, methods for chemical or electrolytic polishing have been occasionally used, but they had high concentrations of chromic acid (50 to 250 g/L) and ultimately yielded unsatisfactory results with regard to surface quality. For this reason, these methods are no longer used. In addition, chromic acid is extremely toxic, carcinogenic, and mutagenic, and therefore its use is expected to be prohibited in the near future within the scope of the European Chemicals Regulation (REACH).

Thus, there is still a great need for suitable methods for chemical or electrochemical polishing and deburring of parts made of diecast zinc.

The invention:

The present invention relates to a method for chemical deburring and polishing of zinc, which may be carried out without chromic acid and without fluorides. The invention is based on the finding that smooth, pore-free zinc surfaces may be obtained in a wet chemical method when the zinc surface is brought in contact with an acid solution containing at least sulfuric acid and phosphoric acid.

The subject matter of the invention therefore relates to a method for wet chemical polishing of molded parts made of zinc, wherein the molded part or the molded parts are brought in contact with an acid solution, the acid solution contains only sulfuric acid and phosphoric acid as the strong acids, and the total acid concentration of these strong acids is in a range of 40 to 90% by weight. The method according to the invention, within a relatively short time period (10 minutes or less), results in zinc surfaces having a significant reduction in the roughness; i.e., the average roughness value Rₐ may be reduced from a starting value of 2.5 μm to 1.4 μm. The method according to the invention is thus carried out, for example, until the average roughness value Rₐ has been reduced at least by 30%, based on the original Rₐ value.

In the method according to the invention, the molded parts at the same time are advantageously deburred.

The molded parts made of zinc which are addressed by the method are generally parts that are obtained from zinc diecasting. However, other methods for manufacturing molded parts made of zinc are also known in the prior art. Zinc may also be present together with magnesium and/or aluminum in an alloy (in which case the maximum copper content is 0.5%). However, the present invention does not relate to such metallic molded parts, which are instead considered as copper alloys containing zinc (brass, for example). The chemical behavior of such alloys is completely different from zinc alloys within the meaning of the present invention. Such copper alloys containing zinc differ from pure zinc metal (which may possibly contain fairly small quantities of other metals), among other things, in their chemical behavior, in that the corrosion resistance, among other characteristics, is strongly influenced by the additional alloying of another metal (in the present case, copper).

Therefore, such a copper alloy also reacts completely differently upon contact with a strong acid, compared to a molded part made of zinc.

Of course, those skilled in the art would expect that a strong acid also dissolves a zinc surface. However, it must be considered surprising to those skilled in the art when in addition to the material removal, a polishing effect may also be achieved by the wet chemical method.

In the present case, wet chemical polishing means that operations are carried out essentially with a solution of the acids in water. Therefore, typically no thickeners or the like are added.

The wet chemical polishing according to the invention advantageously results in deburring of the molded part; i.e., burrs possibly present are removed from the zinc surface, similarly as with grinding. The method according to the invention is usually carried out for a period of time that is long enough to obtain the desired smooth, pore-free surface. This time is generally 5 to 20 minutes. During this time period, a molded part made of zinc may be merely introduced into a bath containing the acid solution according to the invention. However, the process time may also be shortened by moving the molded part in the acid solution.

The wet chemical method according to the invention is normally carried out as a chemical method for polishing molded parts made of zinc. However, in principle it is also possible to carry out this method as an electrochemical method, in which case the zinc molded part itself is used as the electrode in the method.

An important feature of the method according to the invention is that the solution used according to the method contains at least sulfuric acid and phosphoric acid. In the present case, sulfuric acid is understood to mean an approximately 96% sulfuric acid solution, and phosphoric acid, an approximately 85% phosphoric acid solution.

In the present method, the total acid concentration is in a range of approximately 40 to 90% by weight.

The ratio of phosphoric acid to sulfuric acid is generally in a range of 30%:70% to 70%:30%, preferably 50%:50% (% by weight).

In the method according to the invention, in addition an oxidizing agent may be used (which may be omitted in an electrochemical procedure). Persulfates, perchlorates, and peroxides are common oxidizing agents. A stabilizer may also be added to the oxidizing agent (in particular the peroxides); see EP 1 903 081 A2. Preferred oxidizing agents are potassium persulfate, potassium perchlorate, and hydrogen peroxide. For the persulfates and perchlorates, the concentration is usually in a range of 1% to 10%, preferably 2% to 5% (% by weight). For hydrogen peroxide (30%), the concentration is usually in a range of 4% to 20%, preferably 10% (% by weight).

In addition, the acid solution according to the invention may contain a surface-active substance. This surface-active substance should consistently be acid-resistant, for example a wetting agent from the Lutensol product line from BASF, in particular Lutensol FA 12. These wetting agent/surface-active substances may be used in a concentration (% by weight) of 0.2% to 2.5%, preferably 0.8% to 1.0%.

In the normal case, an acid solution according to the invention additionally contains only water. However, other polar solvents may also be present.

The method according to the invention is usually carried out with a contact time between the acid solution and the molded part of up to 20 minutes. However, the process time may also be influenced by other factors such as movement, ultrasound, and temperature gradients.

The working temperature of the method generally is in a range of 15° C. to 60° C. The method is preferably carried out at a temperature in a range of 30° C. to 40° C.

One particular advantage of the present method is that the acid solution contains no chromic acid or chromates, no nitric acid or nitrates, no hydrofluoric acid or fluorides, or, preferably and, no hydrochloric acid or chlorides. As a result, this method is very particularly suited for industrial-scale facilities, since the wastewater that is generated is much more environmentally compatible. In addition, this wastewater may be easily treated, so that it may be reused in the method according to the invention.

All concentrations in this patent application are expressed in % by weight.

### EXAMPLE 1

Hinge part made of diecast zinc with a milled groove and a cross hole, part size approximately 30×20×8 mm

Task: to remove burrs at the cross hole in the groove and smooth the surface for subsequent electroplating.

Bath: 25% sulfuric acid
25% phosphoric acid
5% potassium persulfate
0.6% Lutensol FA 12
Remainder: water

The parts were degreased for 10 minutes in an alkaline hot degreasing process as pretreatment, then rinsed with water, treated for 10 minutes in the solution according to the invention at 35° C., then rinsed with water and dried. The parts treated in this way were burr-free, and had a smooth, lustrous light-gray surface that was suitable for electroplating.

### EXAMPLE 2

Actuation buttons made of diecast zinc for fittings having boreholes and milled edges were to be deburred and their surfaces smoothed for subsequent chrome plating.

Bath: 20% sulfuric acid
30% phosphoric acid
10% hydrogen peroxide
0.8% Lutensol FA 12
Remainder: water

The parts were pretreated according to Example 1, then treated for 15 minutes in the bath at 30° C., rinsed with water, and dried.

The parts treated in this way were burr- and pore-free, and had a smooth, lustrous light-gray surface with smooth, slightly rounded edges. The parts showed perfect surface quality after the chrome plating.

1. A method for the wet chemical polishing of a molded part made of zinc, comprising: bringing the molded part into contact with an acid solution, wherein the acid solution contains only sulfuric acid and phosphoric acid as the strong acids, and the total acid concentration of the strong acids is in a range of 40 to 90% by weight, wherein the acid solution contains no chromic acid/chromates, no nitric acid/nitrates, no hydrofluoric acid/fluorides, and no hydrochloric acid/chlorides, and wherein the acid solution additionally contains an oxidizing agent.

2. The method according to claim 1, wherein the molded part is treated with the acid solution until the average roughness value Rₐ has been reduced at least by 30%, based on the original Rₐ value.

3. The method according to claim 1, wherein the ratio (% by weight) of phosphoric acid to sulfuric acid in the acid solution is in a range of 30%:70% to 70%:30%.

4. The method according to claim 1, wherein the oxidizing agent is selected from the group consisting of persulfates, perchlorates, and peroxides.

5. The method according to claim 1, wherein the oxidizing agent is present in a concentration of 1% to 20% by weight.

6. The method according to claim 1, wherein the solution additionally contains surface-active substances.

7. The method according to claim 1, wherein the contact time between the acid solution and the molded part is up to 20 minutes.

8. The method according to claim 1, wherein the method is carried out at a temperature in a range of 15° C. to 60° C.

9. The method according to claim 8, wherein the temperature is in a range of 30° C. to 40° C.

10. The method according to claim 2, wherein the ratio (% by weight) of phosphoric acid to sulfuric acid in the acid solution is in a range of 30%:70% to 70%:30%.

11. The method according to claim 10, wherein the oxidizing agent is selected from the group consisting of persulfates, perchlorates, and peroxides.

12. The method according to claim 2, wherein the oxidizing agent is present in a concentration of 1% to 20% by weight.

13. The method according to claim 3, wherein the oxidizing agent is present in a concentration of 1% to 20% by weight.

14. The method according to claim 4, wherein the oxidizing agent is present in a concentration of 1% to 20% by weight.

15. The method according to claim 2, wherein the solution additionally contains surface-active substances.

16. The method according to claim 3, wherein the solution additionally contains surface-active substances.

17. The method according to claim 4, wherein the solution additionally contains surface-active substances.

18. The method according to claim 5, wherein the solution additionally contains surface-active substances.

19. The method according to claim 2, wherein the contact time between the acid solution and the molded part is up to 20 minutes.

20. The method according to claim 3, wherein the contact time between the acid solution and the molded part is up to 20 minutes.
